(19) United States
(12) Patent Application Publication
(10) Pub. No.: US 2026/0131518 A1
(43) Pub. Date: May 14, 2026

(54) PARISON AND METHOD FOR FORMING A CONTAINER INCLUDING AN INTERNAL TAPERED BASE

(71) Applicant: AMCOR RIGID PACKAGING USA, LLC, Ann Arbor, MI (US)

(72) Inventors: Bradley S. PHILIP, Tecumseh, MI (US); Brian MATTISON, Chelsea, MI (US)

(21) Appl. No.: 18/875,620

(22) PCT Filed: Jun. 21, 2022
(86) PCT No.: PCT/US2022/034229

§ 371 Date: Dec. 16, 2024

(51) Int. Cl. B29C 49/00; B29C 49/06; B29K 671/00; B29L 31/00

(52) U.S. Cl. CPC B29C 49/071; B29C 49/06; B29C 2949/0715; B29C 2949/0734; B29C 2949/0773; B29C 2949/078; B29K 2671/00; B29L 2031/7158

(57) ABSTRACT

A parison configured to be injection blow molded into a container, and a method therefor. A distal end of the parison is configured to be blown into a container base including an inner surface defining a lower end of the internal volume. The inner surface slopes downward from a sidewall to a radial center of the base such that the radial center is at a lowermost portion of the inner surface of the base, and the inner surface provides a funnel directing contents of the internal volume down to the radial center. An annular flange at a distal end of the parison is configured to be injection blow molded into a standing ring of the container. The parison is configured to form by injection blow molding the standing ring, the inner surface of the base, the container body, and the finish to be monolithic.

### FIELD

The present disclosure relates to a parison and a method for forming a container including an internal tapered base.

### BACKGROUND

This section provides background information related to the present disclosure, which is not necessarily prior art.

While current polymeric containers are suitable for their intended use, they are subject to improvement. For example, existing spray bottles with pump sprayers and dip tubes often have a difficult time evacuating all of the fluid out from within the bottle. The fluid left in the container is often referred to as “hold-up.” An improved method for forming a container that reduces or eliminates container hold-up would be desirable. The present disclosure advantageously provides for an improved parison and method for forming a container configured to eliminate, or at least reduce, fluid “hold-up.” One skilled in the art will appreciate that the present disclosure provides numerous additional advantages and unexpected results, as explained in detail herein and as one skilled in the art will appreciate.

### SUMMARY

This section provides a general summary of the disclosure, and is not a comprehensive disclosure of its full scope or all of its features.

The present disclosure includes a parison configured to be injection blow molded into a container, and a method therefor. A distal end of the parison is configured to be blown into a container base including an inner surface defining a lower end of the internal volume. The inner surface slopes downward from a sidewall to a radial center of the base such that the radial center is at a lowermost portion of the inner surface of the base, and the inner surface provides a funnel directing contents of the internal volume down to the radial center. An annular flange at a distal end of the parison is configured to be injection blow molded into a standing ring of the container. The parison is configured to form by injection blow molding the standing ring, the inner surface of the base, the container body, and the finish to be monolithic.

The present disclosure further includes a method for forming a container. The method includes inserting a core pin into a parison mold configured to form a parison, the parison including: a finish defining an opening of the container; a parison body configured to be injection blow molded into a container body of the container defining an internal volume of the container; a distal end of the parison configured to be injection blow molded into a base of the container including an inner surface of the base defining a lower end of the internal volume, the inner surface slopes downward from a sidewall to a radial center of the base such that the radial center is at a lowermost portion of the inner surface of the base and the inner surface provides a funnel directing contents of the internal volume down to the radial center of the base; and an annular flange included with the distal end of the parison, the annular flange configured to be injection blow molded into a standing ring of the container. The method further includes injecting high-density polyethylene into the parison mold over the core pin to form the parison; removing the core pin with the parison seated thereon out from within the parison mold; inserting the core pin with the parison thereon in a container mold configured to form the container; injection blow molding the parison into the container mold to form the container from the parison such that the standing ring, the inner surface of the base, the container body, and the finish are monolithic; and opening the container mold and removing the container from the container mold.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an exemplary container in accordance with the present disclosure with an exemplary spray tip coupled thereto;

FIG. 2 is a perspective view of the container of FIG. 1;

FIG. 3 is a cross-sectional view taken along line 3-3 of FIG. 2;

FIG. 4 is a cross-sectional view taken along line 4-4 of FIG. 1;

FIG. 5 is a side view of a parison in accordance with the present disclosure configured to form the container of FIG. 1 by injection blow molding, the parison seated in a parison mold;

FIG. 6 is a perspective view of the parison of FIG. 5; and

FIG. 7 illustrates the parison of FIG. 5 seated in a mold configured to form the container of FIG. 1.

Corresponding reference numerals indicate corresponding parts throughout the several views of the drawings.

### DETAILED DESCRIPTION

Example embodiments will now be described more fully with reference to the accompanying drawings.

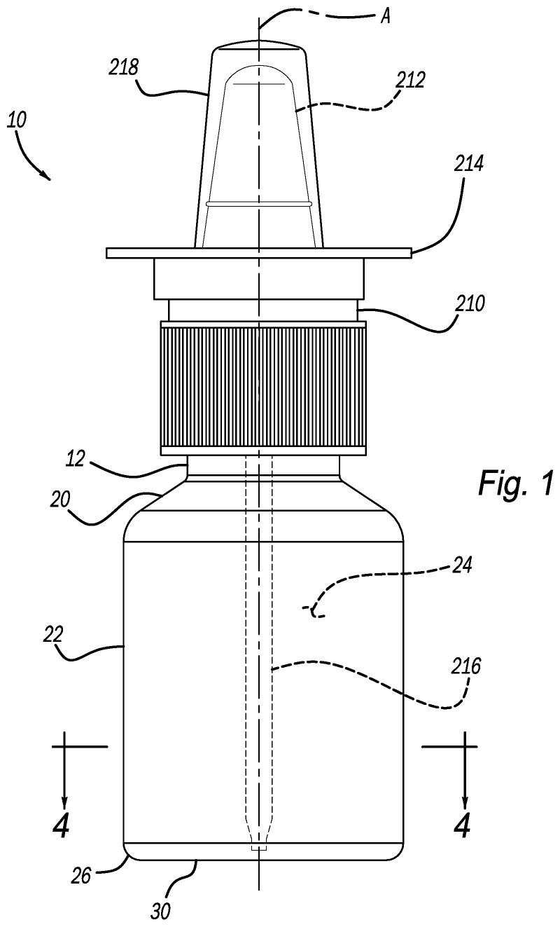

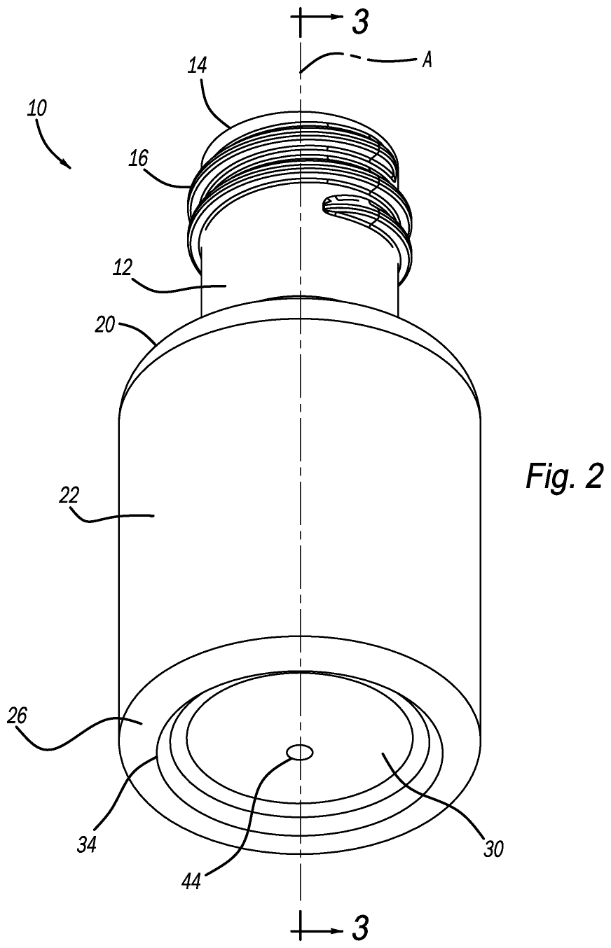

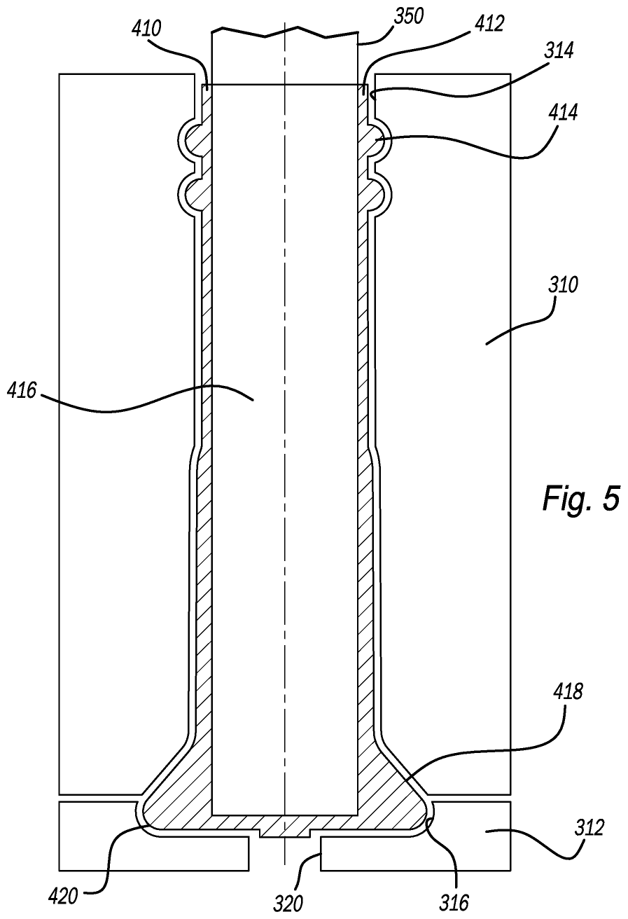

With initial reference to FIGS. 1-4, an exemplary container in accordance with the present disclosure is illustrated at reference numeral 10. The container 10 may have the shape illustrated, or any other suitable shape. The container 10 may be of any suitable size, and may have any suitable capacity as well. The container 10 is formed by injection blow molding (IBM) a parison, such as the parison 410 of FIGS. 5, 6, and 7, as explained in detail herein.

The parison 410 and container 10 are manufactured by the process of injection blow molding (IBM), which is used for the production of plastic objects in large quantities. In the IBM process, the polymer is injection molded onto a core pin, and then the core pin is rotated to a blow molding station to be inflated and cooled. This process is typically used to make small medical and single serve containers. The process is divided into three steps: injection, blowing, and ejection. The injection blow molding machine is based on an extruder barrel and screw assembly, which melts the polymer. The molten polymer is fed into a hot runner manifold where it is injected through nozzles into a heated cavity and core pin. The cavity mold forms the external shape of container 10 and is clamped around a core rod that forms the internal shape of the parison 410. The parison 410 consists of a fully formed bottle/jar neck with a thick tube of polymer attached, which will form the body. The parison mold opens and the core rod is rotated and clamped into the hollow blow mold. The end of the core rod opens and allows compressed air into the preform, which inflates it to the finished article shape. After a cooling period, the blow mold opens and the core rod is rotated to the ejection position. The finished article is stripped off the core rod. The parison mold and blow mold can have many cavities, typically three to sixteen depending on the article size and the required output.

The container 10 may be made of any suitable material. For example, the container 10 may be made of high-density polyethylene (HDPE). HDPE is a thermoplastic polymer produced from the monomer ethylene. Due in part to a high strength-to-density ratio, HDPE may be used in the production of plastic bottles. HDPE is commonly recycled, and has a resin identification code of “2.” HDPE is known for its high strength-to-density ratio. The density of HDPE can range from 930-970 kg/m3. Although the density of HDPE is only marginally higher than that of low-density polyethylene, HDPE has little branching, giving it stronger intermolecular forces and tensile strength (38 MPa versus 21 MPa) than LDPE. The difference in strength exceeds the difference in density, giving HDPE a higher specific strength. It is also harder and more opaque, and can withstand somewhat higher temperatures (120° C./248° F. for short periods).

The container 10 includes a finish 12 defining an opening 14 of the container 10. The finish 12 includes threads 16 configured to cooperate with any suitable closure. In the example illustrated, the threads 16 are external threads, but internal threads are also contemplated by the present disclosure.

Extending downward from the finish 12 is a shoulder 20. The shoulder 20 extends down to a body 22 of the container 10. The body 22 defines an internal volume 24 of the container 10. At a bottom of the body 22 is a heel 26, which extends to a base 30 of the container 10.

The container 10 may be a spray container or bottle configured to cooperate with a spray assembly 210, as illustrated in FIG. 1. The spray assembly 210 is configured to cooperate with the threads 16 to secure the spray assembly 210 to the finish 12 and over the opening 14. The spray assembly 210 may be any conventional spray assembly for a container.

In the example of FIG. 1, the spray assembly 210 includes a spray tip 212 and a spray flange 214 for actuating the spray assembly 210 to dispense liquid out of the container 10 by way of the spray tip 212. More specifically, actuation of the spray flange 214 draws liquid stored within the container 10 into and through a tube 216, and up through the tube 216 to the spray tip 212 where the liquid is sprayed out of the spray tip 212. The tube 216 extends from the finish 12 through the shoulder 20 and the body 22 almost to the base 30. With reference to FIG. 4, the tube 216 is aligned with, and terminates just prior to reaching, a radial center 32 of the base 30.

A longitudinal axis A extends through radial centers of each of the finish 12, the opening 14, the shoulder 20, the body 30, and the radial center 32 of the base 30. The tube 216 extends along the longitudinal axis A.

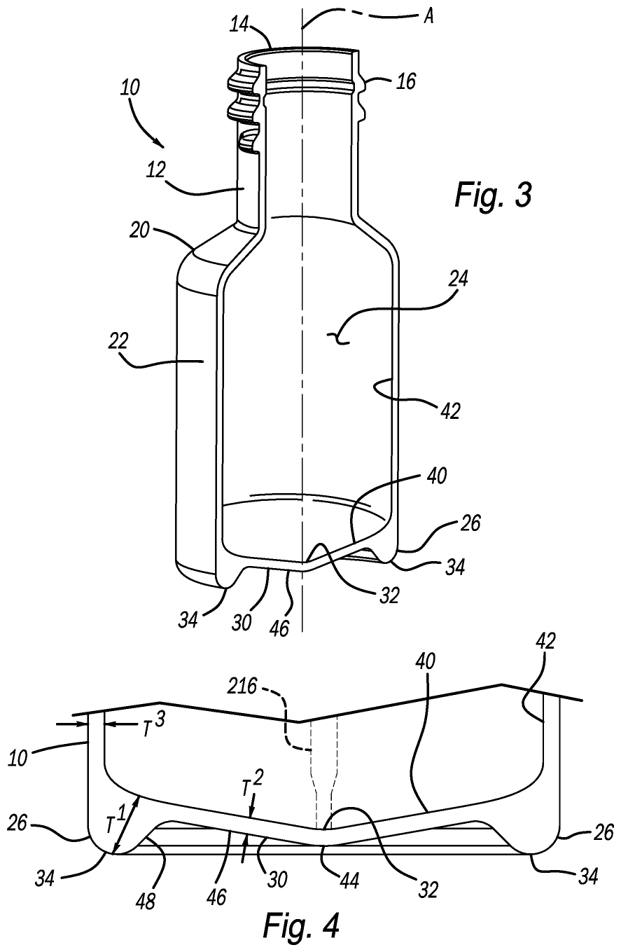

With particular reference to FIGS. 3 and 4, the base 30 further includes a standing ring 34. The standing ring 34 is configured to support the container 10 upright when seated on a flat, or generally flat, surface. An inner surface 40 of the base 30 slopes downward from a sidewall 42 to the radial center 32 of the base 30. The radial center 32 is a lowermost portion of the inner surface 40. The standing ring 34 has a thickness T¹ as measured from a lowermost point of the standing ring 34 to the inner surface 40 of the base 30 opposite to the lowermost point of the standing ring 34, as illustrated in FIG. 4 for example. The thickness T¹ advantageously strengthens the standing ring 34 to support the container 10 upright, and strengthens the inner surface 40 as well. The thickness T¹ is greater than any other thickness of the base 30, such as at thickness T² at the inner surface 40. The thickness T¹ is also thicker than the thickness T³ at the sidewall 42. The thickness T¹ is thicker than any other portion of the container 10, and is thus thicker than a remainder of the container 10.

The inner surface 40 generally provides a funnel directing contents of the internal volume 24 down to the radial center 32 of the base 30. In cross-section, the inner surface 40 has a V-shape. The sloped, funnel provided by the inner surface 40 to the radial center 32 advantageously directs fluid within the internal volume 24 to the tube 216 to facilitate extraction of as much fluid out of the container 10 as possible.

The base 30 further includes a diaphragm 46 and an inner base wall 48. The inner base wall 48 extends from the standing ring 34 inward towards the longitudinal axis A. From the inner base wall 48, the diaphragm 46 extends all the way to the longitudinal axis A. At a radial center of the outer surface of the base 30 is a center outer surface 44, which is opposite to the radial center 32. From the inner base wall 48, the diaphragm 46 slopes downward to the outer surface 44.

The container 10 is a monolithic container in which the finish 12, the shoulder 20, the body 22, the heel 26, and the base 30 are all formed from the same parison 410 by injection blow molding. An exemplary process for forming the container 10 will now be described with reference to FIGS. 5-7. FIG. 5 illustrates a parison mold including a main portion 310 and a distal portion 312. The main portion 310 of the parison mold defines a first cavity 314. The distal portion 312 of the parison mold defines a second cavity 316. The first cavity 314 is configured to form portions of the parison 410 configured to form the finish 412, threads 414, and a parison body 416, which are respectively configured to form the finish 12, the threads 16, the shoulder 20, and at least a majority of the body 22 of the container 10. A distal end 418 of the parison 410 is formed by both the first cavity 314 and the second cavity 316. The distal end 418 of the parison 410 further includes a thick section of material forming an annular flange 420, which is defined by a distal end of the first cavity 314 and the second cavity 316. The annular flange 420 has a thickness that is greater than any other thickness of the parison 410.

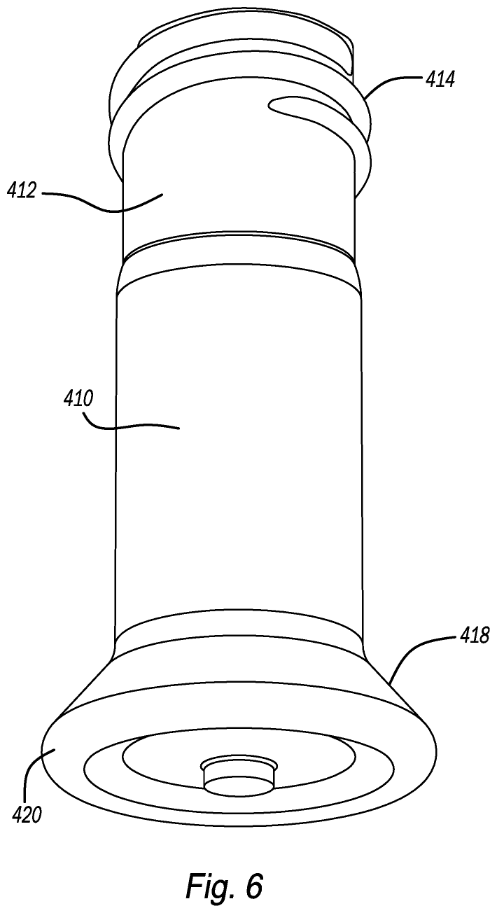

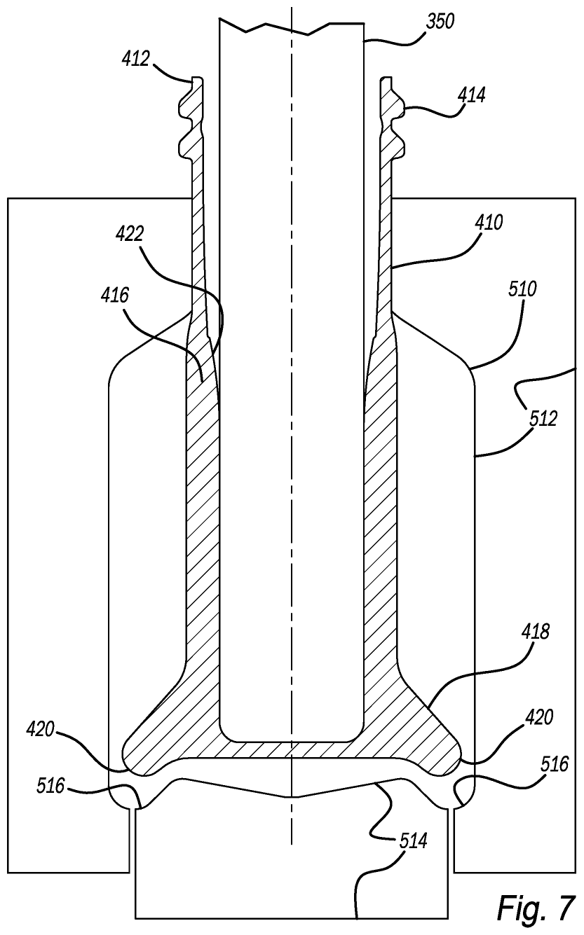

The distal portion 312 of the parison mold further defines a gate 320 at a center of the distal portion 312. It is through the gate 320 that the high-density polyethylene is injected into the distal portion 312 and then the main portion 310 of the parison mold. The high-density polyethylene fills the first cavity 314 and the second cavity 316 to form the parison 410 illustrated in FIG. 6. The high-density polyethylene is injected over a core pin 350 seated in both the main portion 310 and the distal portion 312 of the parison mold. The core pin 350 defines inner cavity 422 of the parison 410 (see FIG. 7). After the parison 410 is formed over the core pin 350 in the parison mold, the main portion 310 and the distal portion 312 of the parison mold are opened to allow the core pin 350, with the parison 410 seated thereon, to be removed and then transferred into a container mold 510 as illustrated in FIG. 7.

The container mold 510 includes a body mold 512 and a base mold 514. The body mold 512 is configured to form the body 22 of the container 10. The base mold 514 is configured to form the base 30 of the container 10. The container mold 510 defines a heel 516. The parison 410 is injection blow molded into the container mold 510 such that the distal end 418 and the annular flange 420 of the parison 410 are stretched into the heel 516 to form the standing ring 34 having a thick section of material. The base mold 514 is generally V-shaped in cross section to form the base 30 of the container 10, which includes the inner surface 40 sloping downward from the sidewall 42 to the radial center 32 of the base 30 to provide the interior of the base 30 with a funnel shape configured to direct contents of the internal volume 24 down to the radial center 32, which is opposite to the tube 216 of the spray assembly 210.

After the parison 410 is blown into the container mold 510, the container 10 is allowed to cool prior to the container mold 510 being opened. After cooling, the base mold 514 retracts and the container mold 510 opens and the core pin 350 moves the container 10 out of the container mold 510.

The present disclosure thus advantageously provides for the container 10 with the finish 12, the shoulder 20, the body 22, the heel 26, and the base 30 all unitary and monolithic, with the container 10 formed during a single injection blow molding process of the parison 410. This advantageously eliminates any need to manufacture separate parts of the container 10, such as the base 30 and specifically the standing ring 34, by individual molding steps, and then attaching the standing ring 34 or other portions of the base 30 to a remainder of the container 10. Injection blow molding the entire container 10 in one process advantageously reduces costs, reduces manufacturing time, and increases the overall quality of the container 10. One skilled in the art will appreciate that the present disclosure provides numerous additional advantages and unexpected results.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A parison configured to be injection blow molded into a container, the parison comprising:
a finish defining an opening;
a parison body configured to be injection blow molded into a container body of the container defining an internal volume of the container;
a distal end of the parison configured to be injection blow molded into a base of the container including an inner surface of the base defining a lower end of the internal volume, the inner surface slopes downward from a sidewall to a radial center of the base such that the radial center is at a lowermost portion of the inner surface of the base and the inner surface provides a funnel directing contents of the internal volume down to the radial center of the base; and
an annular flange included with the distal end of the parison, the annular flange configured to be injection blow molded into a standing ring of the container;
wherein the parison is configured to form by injection blow molding the standing ring, the inner surface of the base, the container body, and the finish to be monolithic.

2. The parison of claim 1, wherein the parison is configured to form the standing ring and the inner surface to each have a thickness that is relatively thicker than a remainder of the base.

3. The parison of claim 1, wherein the parison is configured to form the container as a spray bottle.

4. The parison of claim 3, wherein the finish is configured to cooperate with a spray cap with a tube extending from the spray cap nearly to the radial center of the base.

5. The parison of claim 1, wherein the parison is configured to form the container to be entirely monolithic.

6. The parison of claim 1, wherein the parison is configured to form the inner surface of the base to be v-shaped in cross-section.

7. The parison of claim 1, where the parison is formed of high-density polyethylene.

8. The parison of claim 1, wherein the parison is configured to form an outer surface of the base by injection blow molding, the outer surface surrounded by the standing ring and angled outward such that a lowermost portion of the outer surface is at the radial center of the base.

9. The parison of claim 1, wherein the annular flange has a thickness that is greater than any other portion of the parison.

10. A method for forming a container, the method comprising:
inserting a core pin into a parison mold configured to form a parison, the parison including:
a finish defining an opening of the container;
a parison body configured to be injection blow molded into a container body of the container defining an internal volume of the container;
a distal end of the parison configured to be injection blow molded into a base of the container including an inner surface of the base defining a lower end of the internal volume, the inner surface slopes downward from a sidewall to a radial center of the base such that the radial center is at a lowermost portion of the inner surface of the base and the inner surface provides a funnel directing contents of the internal volume down to the radial center of the base; and
an annular flange included with the distal end of the parison, the annular flange configured to be injection blow molded into a standing ring of the container;
injecting high-density polyethylene into the parison mold over the core pin to form the parison;
removing the core pin with the parison seated thereon out from within the parison mold;
inserting the core pin with the parison thereon in a container mold configured to form the container;
injection blow molding the parison into the container mold to form the container from the parison such that the standing ring, the inner surface of the base, the container body, and the finish are monolithic; and
opening the container mold and removing the container from the container mold.

11. The method of claim 10, further comprising securing a spray cap to the finish of the container.

12. The method of claim 11, further comprising arranging a tube extending from the spray cap at the radial center of the base.

13. The method of claim 10, wherein the base includes an outer surface surrounded by the standing ring, the outer surface is angled outward such that a lowermost portion of the outer surface is at the radial center of the base.

14. The method of claim 10, further comprising forming the container such that the standing ring is relatively thicker than a remainder of the container.

15. The method of claim 10, wherein the annular flange is formed by an annular recess defined by the parison mold to have an annular flange thickness that is greater than a remainder of the parison.

16. The method of claim 10, wherein the injection blow molding of the parison into the container mold includes injection blow molding the annular flange into a body mold and a base mold of the container mold to form the standing ring with a thickness that is relatively thicker than a remainder of the container.

17. The method of claim 10, further comprising forming the container such that the standing ring is relatively thicker than a wall of the container.

18. The method of claim 10, further comprising forming the container such that the standing ring is relatively thicker than a remainder of the base of the container.
